(19) United States
(12) Patent Application Publication
(10) Pub. No.: US 2025/0307598 A1
(43) Pub. Date: Oct. 2, 2025

(54) CHAIN-OF-THOUGHT REASONING WITHOUT PROMPTING

(71) Applicant: Nathan TRUDEAU, Varennes (CA)

(72) Inventor: Nathan TRUDEAU, Varennes (CA)

(21) Appl. No.: 19/078,681

(22) Filed: Mar. 13, 2025

Related U.S. Application Data
(60) Provisional application No. 63/564,972, filed on Apr. 2, 2024.

(51) Int. Cl. G06N 3/042; G06F 40/284; G06N 3/0455

(52) U.S. Cl. CPC G06N 3/042; G06F 40/284; G06N 3/0455

(57) ABSTRACT

Methods and systems for eliciting inherent CoT reasoning from pre-trained neural network language models without modifications such as prompting or tuning are provided. Rather than greedy decoding, branching on top-k tokens during generation naturally uncovers latent reasoning paths within models. Increased confidence when generating answers via reasoning trajectories enables isolation of reliable CoT decoding paths, significantly boosting accuracy over diverse reasoning tasks. The techniques elicit and leverage untapped reasoning potential within large models without altering parameters or training.

### CROSS REFERENCE

This application claims priority to U.S. Provisional Application No. 63/564,972, titled “CHAIN-OF-THOUGHT REASONING WITHOUT PROMPTING,” filed Mar. 13, 2024.

### FIELD

The present disclosure relates generally to artificial intelligence and natural language processing technologies, and more specifically to methods for eliciting reasoning capabilities in large language models without the use of prompting techniques.

### BACKGROUND

Recent research by Wang and Zhou (Xuezhi Wang and Denny Zhou, “Chain-of-Thought Reasoning Without Prompting,” arXiv preprint arXiv:2302.08565 (2023)) demonstrates that latent Chain-of-Thought (CoT) reasoning abilities exist within large language models. However, this prior work does not provide specific techniques to reliably extract this reasoning beyond brute force examination of all possible decoding paths. The paper suggests increased model confidence indicates valid reasoning trajectories but does not detail methods to leverage this signal.

There is a need for techniques to algorithmically isolate inherent CoT reasoning from language models in an efficient, targeted manner during decoding. The present invention addresses this need with methods to harness model confidence patterns and other heuristics to extract reliable reasoning paths without exhaustive enumeration.

### SUMMARY

The present invention introduces techniques to selectively extract inherent CoT reasoning trajectories from language models using confidence scoring, dynamic beam width adjustment, and other algorithms. While the above-cited paper shows latent reasoning ability in large models, the current invention provides the missing methods to harness this capability efficiently and reliably. We develop heuristics and metrics to guide extraction of valid CoT paths during decoding.

In one embodiment, we adjust beam width dynamically based on entropy to expand search space in uncertain regions. We also track model confidence on answers generated via different reasoning paths, allowing isolation of high-confidence trajectories. Together, these algorithms approximate brute force examination of all decoding paths while minimizing combinatorial costs. They elicit inherent reasoning without exhaustive enumeration or explicit prompting.

Advantages of selectively extracting CoT include:
Bypasses brute force search through efficient guidance mechanisms.
Leverages model signals like confidence and entropy.
Maintains pre-trained model state without tuning.
Achieves accuracy gains by targeting reliable trajectories.
Widely applicable across diverse reasoning tasks and models.

In an illustrative embodiment, the inventive system comprises a pre-trained language model and a chain-of-thought decoder. The decoder is configured to receive an input text representing a reasoning task, generate top-k alternative tokens at each decoding step, analyze decoding paths to isolate high-confidence trajectories, and output an extracted reasoning trajectory for solving the task. The system may dynamically adjust the beam width during decoding based on the entropy of model outputs, calculate confidence scores for generated tokens using weighted probability calculations, and implement approximate chain-of-thought generation for longer inputs while maintaining high confidence in the overall reasoning path.

By branching on the top-k tokens during decoding, rather than solely using greedy decoding, the system frequently uncovers reasoning within these alternatives. The CoT decoding method extracts reliable trajectories, significantly boosting accuracy across diverse reasoning tasks. Experiments demonstrate the inherent presence and efficacy of extracted CoT reasoning without any modifications to the underlying models.

Overall, the present invention provides novel techniques absent in prior art to harness the latent reasoning abilities practically and efficiently within large pre-trained language models.

### BRIEF DESCRIPTION OF THE DRAWINGS

FIG. 1 is a system architecture diagram of an embodiment; and

FIG. 2 is a flowchart of the CoT decoding process in an embodiment.

### DETAILED DESCRIPTION

### Overview

The present disclosure demonstrates that pre-trained neural network language models inherently contain latent reasoning capabilities. Rather than relying on specialized prompting or model tuning, we show that logical CoT paths naturally emerge when examining alternative decoding trajectories.

Specifically, by branching on the top-k tokens during decoding, rather than solely greedy decoding, reasoning is frequently uncovered within these alternatives. We introduce a method called CoT decoding to extract such reliable trajectories, significantly boosting accuracy. Experiments across diverse reasoning tasks demonstrate the inherent presence and efficacy of extracted CoT reasoning without any modifications to models. Our techniques surface and leverage latent reasoning abilities within large pre-trained models.

### System Architecture

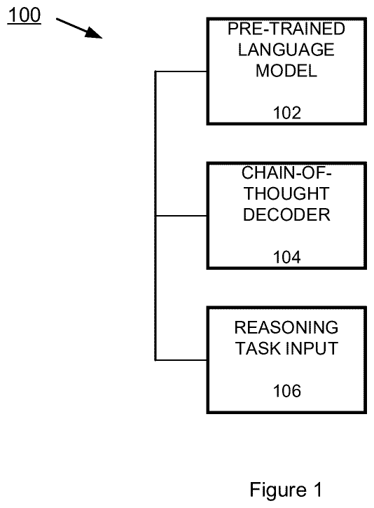

FIG. 1 illustrates a high-level architecture of an embodiment of the present system for extracting inherent CoT reasoning from language models. The system contains the following key components:

Pre-Trained Language Model (102)—This module represents the large neural network language model which has been pre-trained on massive text corpora. It is implemented as a transformer model with encoder-decoder architecture using software libraries like PyTorch, TensorFlow, Jax, or the like. The pre-trained weights encode strong general language abilities. When provided with an input text prompt, the model can generate coherent continuations in a natural language.

CoT Decoder (104)—This is a key module containing logic to drive the specialized decoding process to extract inherent reasoning trajectories. It is implemented in software code containing algorithms like confidence scoring, beam width adjustment, and path ranking. During decoding, it instructs the model to generate top-k alternatives and analyzes the results to isolate high-confidence CoT paths. The output is the extracted reasoning trajectory for solving the given task.

Reasoning Task Input (106)—This module provides the input text representing the reasoning question or prompt to be solved. It can be implemented as a simple text string input in software. In an embodiment, the input may be formatted as a question in natural language pertaining to the target reasoning task, such as “How many apples do we have in total?” for a math word problem.

Input Processor—This module, not shown in FIG. 1, involves at least one of a forwarding and a processing of the raw text input for consumption by the model. In an embodiment, such involves performing a conversion to tokens using a tokenizer, thereby leading to an encoded representation of the input text ready for the model.

The system architecture combines a powerful pre-trained language model with specialized algorithms to efficiently extract latent reasoning compared to, for instance, brute force techniques. The software and neural network components work together to uncover inherent logic that can be leveraged to amplify reasoning ability.

### Operation

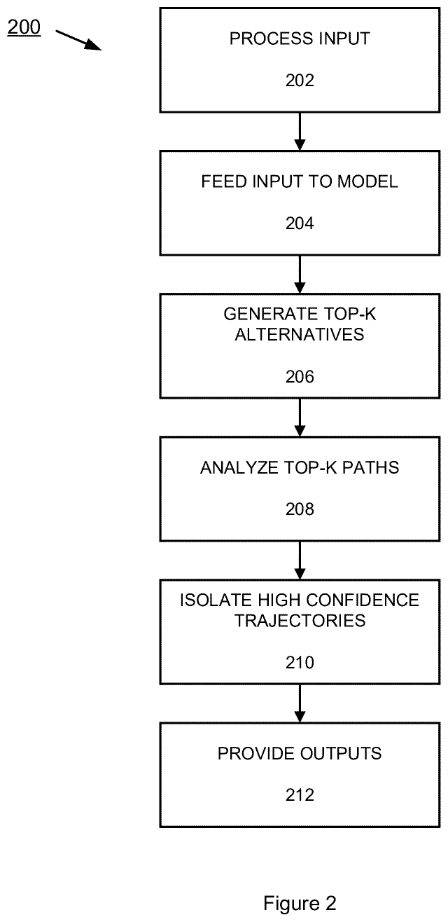

FIG. 2 shows a flowchart of the CoT decoding process. A reasoning input or question 106 is provided to the Pre-trained Language Model 102. The input is processed (202) for model consumption, such as by leveraging tokenization. In one implementation, the AutoTokenizer from HuggingFace transformers library is used to tokenize the text input.

The processed input is fed into the model 204. Rather than solely greedy decoding, the model is instructed to generate top-k alternatives 206 on obtained logits. In an embodiment, the model is configured to generate top-k alternatives on obtained logits based on a dynamically selected k-value. In an embodiment, this dynamic selection considers the historical average entropy of the model's outputs and the desired target adjustment mode, such as precision or creativity. The k-value can be adjusted using factors derived from the deviation of the current entropy from its historical average, enabling more precise or more creative generations depending on the specific application requirements. Additionally, minimum and maximum thresholds can be set to constrain the range of allowed k-values, ensuring consistent and controlled behavior.

The AutoModelForCausalLM is a pre-trained transformer language model from HuggingFace Transformers that leverages an encoder-decoder architecture, characterized by a causal mask applied on the decoder side, which facilitates the model's focus on the input context. Once the input is received, it is encoded, and this encoded representation is then propagated to the decoder.

The CoT Decoder 104 (FIG. 1) analyzes the top-k decoding paths 208 and isolates high confidence trajectories 210. It leverages the observation that paths imbued with higher logical certainty increase the model confidence in the final decoded answer. In an embodiment, a specialized function calculates the confidence scores for each option within the beam search, employing weighted probabilities of the top-k tokens normalized against their logits. Those paths exhibiting the highest confidence scores are determined as leading candidates for the CoT reasoning paths. In an embodiment, the top n candidates are preserved in memory for every token produced, enabling, in an embodiment, more precise determinism of the optimal CoT path according to subsequent tokens generated. In an embodiment, early stopping techniques are leveraged, such as a predetermined token is generated and/or a predetermined number of tokens are generated. The selected high-confidence candidate is then output (212) to address the reasoning task at hand.

To generate the top-k tokens at each step, the decoder produces a logit vector spanning the vocabulary, from which scores are derived to indicate the model's preference of each token. The k highest scoring tokens are then identified in the logit vector, their indices representing the preferred options for sequence extension. This process is autoregressive, incorporating previously generated tokens into the context for subsequent iterations. Through this methodology, the decoder employs a combination of argmax and top k functions to iteratively select the top-k scoring tokens and extend the decoding path autoregressively, incorporating previously generated tokens into the context for each subsequent iteration.

### Pseudocode Example

The implementation introduces dynamic k-value selection based on cumulative probabilities and logits' entropy, optimizing from precision to creativity in generated outputs.

### Select k Target Values Dictionary

Encapsulates baseline parameters for dynamic k-value adjustment, tailored to either “more precise” or “more creative” outputs. These parameters include baseline_threshold, entropy_scale, min_threshold, and max_threshold, each with specific roles in modulating the selection range of top k logits. These parameters work together within the select_k_target_values dictionary to customize the text generation process, offering customizable options for generating outputs that range from highly precise to creatively diverse.
baseline_threshold: This parameter sets the cumulative probability threshold for selecting the top k logits. A lower baseline_threshold (e.g., 0.5 for more precise outputs) focuses on the most probable tokens, enhancing precision by limiting selection to the most likely options. A higher baseline_threshold (e.g., 0.9 for more creative outputs) broadens the selection range, allowing for greater diversity and creativity by including less probable tokens.
entropy_scale: Adjusts the baseline_threshold based on the entropy of the logits distribution, where entropy is a measure of uncertainty or variability in the model's predictions. A lower entropy_scale (e.g., 0.01 for more precise outputs) diminishes the effect of high entropy, ensuring that even in uncertain scenarios, the adjustment to the baseline_threshold is minimal, maintaining precision. A higher entropy_scale (e.g., 0.1 for more creative outputs) enhances the effect of entropy, allowing for significant adjustments to the baseline_threshold in high-uncertainty situations, thus promoting diversity and creativity.
min_threshold: Sets the minimum cumulative probability threshold, ensuring that the selection of top logits does not fall below a certain level of certainty. A lower min_threshold (e.g., 0.65 for more precise outputs) means a narrower selection range, focusing on the most probable outcomes and thus enhancing precision. A higher min_threshold (e.g., 0.7 for more creative outputs) allows for a broader selection of logits, supporting the generation of more diverse and creative content.
max_threshold: Defines the maximum allowable cumulative probability threshold, placing an upper limit on the breadth of logits considered for selection. A lower max_threshold (e.g., 0.75 for more precise outputs) imposes a tighter constraint, limiting exploration even in high-entropy situations to maintain coherence and precision. A higher max_threshold (e.g., 0.95 for more creative outputs) accommodates a wider selection of logits in response to high uncertainty, encouraging exploration and enhancing the creativity of the outputs.

### Adjust Factor Based on Entropy Function

Dynamically adapts the k-value selection factor based on the deviation of the current entropy from its historical average. This adaptation enables the model to optimize from precision to creativity. Main parameters:
history: A tensor containing the history of entropy values encountered during the model's predictions.
target: The target mode for adjusting the factor, either ‘precision’ or ‘creativity’.
aggressivity_level: A value that determines the aggressiveness of the adjustment.

First, it calculates the valid historical average entropy by excluding any uninitialized values (zeros), considering only the authentic entropy history. In cases where valid_history length is 1, the function returns an adjustment factor of 1.0, indicating the absence of sufficient history for meaningful adjustments.

Then, the deviation is computed by taking the standard deviation of valid_history, a tensor. The STD provides insight of fluctuation levels in the model's understanding of the input context, informing the required adjustment to the k-value selection factor.

Based on the specified optimization mode (i.e., “precision” or “creativity’), the function adapts the factor, enabling a determining of the desired level of the target optimization mode. In the case of “precision,” a higher deviation (either positive or negative) should tighten the selection, which is achieved by subtracting a value proportional to the deviation from 1.0. The subtraction is regulated by the aggressivity_level parameter, preventing excessive tightening. In the case of “creativity,” a higher positive deviation loosens the selection, while a negative deviation tightens it slightly. The balance between tightening and loosening is adjusted using a value proportional to the deviation while being regulated by the aggressivity_level. In this mode, the factor is capped to values >=than 1.0. The aggressivity_level controls the extent of factor adjustment and can be fine-tuned to attain desired balancing behavior based on use cases.

### Select k Function

Acts as the core of dynamic k-value selection. It aims at intelligently identifying the most optimal k-value based on the entropy history & model's predictions. Main parameters:
logits: Tensor containing the logits output by the model for the last token. The logits represent the model's predicted probability distribution across all candidate tokens.
entropy_history: A tensor containing the history of entropy values. Entropy is a measure of uncertainty or variability in the model's predictions. Maintaining an entropy history enables the learning and adaptation of the k-value selection strategy based on the model's understanding of the input context.
target: The target mode for dynamic k-value selection; defaults to “more precise”.
auto_adjust_for: The strategy for adjusting k-value selection based on the model's performance. It could be set to “precision”, “creativity”, or “none”; defaults to “precision”.
aggressivity_level: The aggressiveness level for the adjustment; defaults to 0.25. Passed to adjust_factor_based_on_entropy.

Initially, the function assesses the current entropy of the logits to understand the predictability of the model's outputs. It then updates the entropy_history with this new entropy value, maintaining a log of previous entropy measurements. This historical entropy information is critical for adjusting the selection strategy in response to the changing understanding of the input context.

Following this, an adjustment factor is derived using the adjust_factor_based_on_entropy function, considering the entropy_history. This factor modifies essential parameters, i.e., baseline_threshold, entropy_scale, min_threshold, and max_threshold, to align the selection process with the intended level of precision or creativity.

At its core, the function calculates the adjusted_threshold, which combines the baseline threshold with an adjustment based on the current entropy, constrained by the minimum and maximum thresholds.

Probabilities are then sorted in descending order, cumulatively summed to identify the count of top logits that reach or exceed the adjusted threshold. By adding one to this count, the function pinpoints the minimal set of top logits necessary to meet or surpass the threshold, determining the k-value. This carefully chosen k-value ensures that predictions remain focused, respecting the desired balance between precision and creativity.

Through this process, the select_k function adeptly adjusts the considered logits range during text generation. It capitalizes on the model's prediction nuances and entropy history to enhance output coherence and diversity, showcasing sophisticated control over the generative process informed by both intelligence and contextual awareness.

### Model Confidence Function

Computes the weighted confidence scores for selected top token indices based on their logits. Main parameters:
logits: A tensor of logits from the model for the last token, which are essentially the model's raw predictions for each token in the vocabulary.
top_indices: A tensor of indices for the top tokens, identified as the most likely next tokens by the model.

It operates by first transforming the logits for the last token into probabilities through the softmax function. The function then proceeds to identify the probabilities associated with the top token indices, which are essentially the indices of the tokens deemed most likely by the model.

To enhance the precision of these probabilities, the function employs a weighting mechanism. This mechanism multiplies the identified probabilities by the exponential of their respective logits, adjusted by subtracting the maximum logit value for numerical stability. Such weighting emphasizes the significance of tokens with higher logits, correlating with a higher model confidence in those tokens being the correct next choices in the sequence.

Subsequent to the weighting step, the function normalizes these weighted probabilities to ensure their sum equals one, effectively converting them into relative confidence scores for each top index. This normalization is crucial for interpreting the weighted probabilities as measures of confidence, enabling a clear understanding of the model's certainty in its predictions.

The outcome of this process is a list of confidence scores for each selected top index. These scores provide insight into the model's level of certainty regarding its predictions, facilitating an evaluation of the most probable and coherent paths for text generation. This approach allows for a nuanced assessment of the model's predictions, highlighting the paths where the model exhibits a higher degree of confidence and thus potentially enhancing the relevance and accuracy of generated text.

### Enhanced CoT Beam Search Function

Implements an advanced approach to Chain-of-Thought (CoT) beam search decoding by incorporating dynamic k-value selection, model confidence assessment, and the option for approximate CoT generation. This sophisticated method facilitates efficient and nuanced text generation, with an array of parameters allowing for deep customization:
input_text: The input text for generating continuations.
max_length: The maximum length of the generated text.
dynamical_k: Whether to use a dynamic value for k during beam search. Defaults to True.
max_batch_size: Maximum batch size for processing sequences. Defaults to 8.
memory_clear_batch_num_limit: Number of batches to process before clearing memory. Defaults to 16.
approximate_cot: Whether to use approximate CoT for multiple characters generation. Defaults to False.
approximate_cot_batch_size: Batch size for approximate CoT generation. Defaults to 4.
default_num_beams: Default number of beams to use during beam search. Defaults to 5.
force_precise_cot_init_tokens_count: Number of tokens to generate before using approximate CoT. Defaults to 1.
dynamic_cot_threshold: Confidence threshold below which approximate CoT is disabled. Defaults to 0.8.
temperature: Temperature to adjust distribution sharpness. Defaults to 1.0.
select_k_target: Target for dynamic k-value selection. Defaults to “more precise”.
elect_k_auto_adjust_for: Adjustment strategy based on model's performance. Options: “precision”, “creativity”, or “none”. Defaults to “precision”.
select_k_auto_adjust_aggressivity_level: Aggressivity level for the adjustment. Defaults to 0.25.

The function commences with initializing the entropy_history tensor and preparing the input text for processing. It then proceeds through iterative decoding, generating candidate sequences with the possibility of employing dynamic k-value selection for enhanced adaptability. Model confidence scores are calculated for top logits using the model_confidence function, embedding a layer of insight into the model's certainty regarding its predictions.

When approximate CoT generation is enabled, sequences are expanded based on approximate_cot_batch_size, optimizing for both efficiency and output quality. This feature is dynamically managed according to the dynamic_cot_threshold, ensuring the maintenance of quality where the model's confidence wanes.

Following sequence generation, candidates are sorted and trimmed based on their scores and lengths, adhering to the max_batch_size constraint. The algorithm continuously updates the best sequence and evaluates termination criteria, such as reaching the maximum length or encountering an end token, to conclude the generation process.

The pseudocode example highlights some of the key innovations in the code implementation for extracting chain-of-thought reasoning trajectories. This includes functions for dynamic beam width selection, confidence scoring, and the overall beam search process.

The select_k function implements the dynamic selection of beam width k based on cumulative probability thresholds and historical entropy. It auto-tunes parameters at runtime to target precision or creativity. The model_confidence function applies custom weighting and normalization of probabilities and logits to compute specialized confidence scores.

The enhanced_cot_beam_search orchestrates the overall process, including top-k token generation, confidence scoring, early stopping checks, and batch processing optimizations. It provides extensive configuration options to tune the search for optimal reasoning paths.

Together, these algorithms and helper functions transform the conceptual approach of the paper into an efficient, customizable implementation. The code realizes key innovations like dynamic k selection and confidence scoring while optimizing for practical deployment.

### EXAMPLE

Below is an excerpt of Table 5 in the paper, with outputs from the present invention. enhanced_cot_beam_search parameters used:
template, max_length=len(input_text)+5000
dynamical_k=True
max_batch_size=8
memory_clear_batch_num_limit=16
approximate_cot=False (set to True for “Dynamic CoT Decoding (approx. enabled)”)
approximate_cot_batch_size=4
default_num_beams=5
force_precise_cot_init_tokens_count=5
dynamic_cot_threshold=0.8
select_k_target=“more precise”
select_k_auto_adjust_for=“precision”
select_k_auto_adjust_aggressivity_level=0.25
1. Input (GSM8k): Claire makes a 3 egg omelet every morning for breakfast. How many dozens of eggs will she eat in 4 weeks?
   Greedy (Paper): 3
   CoT Decoding (Paper): A dozen is 12. 3 eggs per day for 4 weeks is 84 eggs. 84/12=7. 7 dozen eggs.
   Few-Shot CoT (Paper): There are 7 days in a week. 4 weeks is 4*7=28 days. She eats 3 eggs each day, so in 28 days she eats 28*3=84 eggs. 1 dozen is 12 eggs. 84 eggs is 84/12=7 dozen eggs. The answer is 7.
   Zero-Shot CoT (Paper): First, how many eggs does she eat in a week? 7 days in a week, 3 eggs per day, so 7×3=21 eggs per week. Now, how many eggs does she eat in 4 weeks? 4×21=84 eggs. Now, how many dozens of eggs is that? 84/12=7 dozens.
   Dynamic CoT Decoding: To find out how many eggs Claire uses in 4 weeks, we can multiply the number of eggs she uses each morning by the number of days in 4 weeks.
      We know that:

$$1 dozen = 12 eggs$$

So, first, let's calculate how many eggs Claire uses in 4 weeks:

$$Eggs used in 4 weeks = Eggs used per day \times Number of days = 3 eggs / day \times ( 7 days / week \times 4 weeks ) = 3 eggs / day \times 28 days = 84 eggs$$

Now, to convert this number to dozens, we divide the number of eggs by the number of eggs in a dozen:

$$Dozens of eggs = Number of eggs / Eggs per dozen = 84 eggs / 12 eggs / dozen = 7 dozens$$

So, Claire will eat 7 dozens of eggs in 4 weeks.
Dynamic CoT Decoding (approx. enabled): To find out how many eggs Claire will use in 4 weeks, we simply need to multiply the number of eggs she uses each morning by the number of days in 4 weeks.
   We know that:

$$1 dozen = 12 eggs$$

So, let's calculate the number of eggs Claire uses in 4 weeks:

$$Eggs used in 4 weeks = Eggs used per day \times Number of days$$

First, let's convert “3 egg omelet” into a number of eggs:

$$Eggs per days = 3 eggs$$

Next, calculate the number of days in 4 weeks:

$$1 week = 7 days$$

$$4 weeks = 4 \times 7 = 28 days$$

Now, calculate the number of eggs used in 4 weeks:

$$Eggs used in 4 weeks = 3 eggs / day \times 28 days = 84 eggs$$

Finally, convert the number of eggs into dozens:

$$Dozens of eggs = Eggs used / Eggs per dozen$$

$$Dozens of eggs = 84 eggs / 12 eggs / dozen = 7 dozens$$

So, Claire will use 7 dozens of eggs in 4 weeks.

### Example Use Case: Automated Code Debugging and Optimization System

A CoT-enabled code debugging system could significantly enhance software development processes. The implementation would involve:
Analyzing code structure and logic flow.
Identifying potential error sources systematically.
Generating step-by-step debugging processes.
Suggesting optimizations with explanations.

For example, when debugging a complex function, the system could:
1. Analyze the function's inputs and expected outputs.
2. Trace the execution path step-by-step.
3. Identify potential points of failure or inefficiencies.
4. Suggest specific code modifications with explanations.
5. Propose alternative algorithms or data structures for optimization.

This implementation would streamline the debugging process and help developers understand and improve their code more effectively.

An Automated Code Debugging and Optimization System leveraging the Chain-of-Thought (CoT) reasoning extraction techniques described in the provisional patent application would work as follows:

The system would include the following key components:
1. Pre-Trained Language Model (102): A large neural network model pre-trained on vast amounts of code and programming-related text.
2. CoT Decoder (104): The specialized module containing algorithms for extracting inherent reasoning trajectories during code analysis.
3. Code Input (106): Source code to be debugged or optimized, provided as input to the system.

The system would operate through the following steps:
1. Code Ingestion: The source code is processed and tokenized for consumption by the pre-trained language model. Tokenization converts the raw text into a format the model can understand. It breaks down the code into smaller units (tokens) that correspond to the model's vocabulary. This step is necessary for maintaining consistency between how the model was trained and how it processes new inputs. The same tokenization method used during training must be applied to new inputs for the model to interpret them correctly. Tokenization allows the model to handle various programming languages and coding styles uniformly, enabling it to work with diverse codebases.
2. Analysis Initiation: The system prompts the model with a task related to debugging or optimization, such as “Identify and explain potential bugs in this code” or “Suggest optimizations for this function.” The system prompts the model with a specific task because: It provides a clear direction for the model's analysis, focusing its attention on the desired outcome (debugging or optimization). This step leverages the model's general language understanding capabilities to interpret the task and apply it to the given code context. By framing the task as a natural language prompt, it allows the model to engage its reasoning capabilities in a way that mimics human problem-solving approaches.
3. CoT Decoding: Instead of greedy decoding, the CoT Decoder instructs the model to generate top-k alternative tokens at each step. This approach allows for exploration of multiple reasoning paths simultaneously, increasing the chances of discovering valid logical trajectories. By considering alternatives, the system can uncover latent reasoning capabilities that might be missed by simple greedy decoding. This method aligns with the core innovation of the invention, which is to extract inherent chain-of-thought reasoning without explicit prompting or model modifications.
4. Path Analysis: The decoder analyzes the various decoding paths, looking for high-confidence trajectories that indicate logical reasoning about the code. High confidence in generated tokens often correlates with more logical and coherent reasoning paths. This step allows the system to differentiate between random generations and those that exhibit structured, step-by-step analysis of the code. By focusing on high-confidence trajectories, the system can filter out noise and irrelevant generations, improving the quality of the final output.
5. Reasoning Extraction: The system isolates the most promising reasoning paths, which represent the model's step-by-step analysis of the code. These paths represent the model's step-by-step analysis of the code, providing insights into its “thought process” for debugging or optimization. By extracting these paths, the system can present a coherent and logical explanation of potential bugs or optimization opportunities. This step transforms the raw model outputs into actionable insights that can be easily understood and applied by developers or automated systems. This approach works effectively because it leverages the latent reasoning capabilities of pre-trained language models without requiring specialized prompting or fine-tuning. By exploring multiple decoding paths and analyzing their confidence levels, the system can uncover inherent chain-of-thought reasoning that might otherwise remain hidden in traditional decoding approaches.

The system would employ several innovative techniques:
1. Dynamic Beam Width Adjustment: The select_k function would dynamically adjust the beam width based on the entropy of the model's outputs. For code analysis, this could help expand the search space when the model encounters complex or ambiguous code sections.
2. Confidence Scoring: The model_confidence function would calculate weighted confidence scores for generated tokens. In the context of code analysis, higher confidence scores might indicate more reliable bug identifications or optimization suggestions.
3. Approximate CoT Generation: For longer code sections, the system could use the approximate_cot feature to generate multiple analysis steps efficiently, while still maintaining high confidence in the overall reasoning path.

### Dynamic Beam Width Adjustment

The dynamic beam width adjustment technique is a crucial innovation in the proposed system for code analysis. This approach allows the model to adapt its search space based on the complexity and ambiguity of the code being analyzed.

How it works:
1. The select_k function evaluates the entropy of the model's outputs at each decoding step.
2. When encountering complex or ambiguous code sections, the function increases the beam width.
3. For simpler or more straightforward code, the beam width may be reduced.

Benefits:
Improved efficiency by allocating more resources to challenging code sections.
Enhanced ability to explore alternative interpretations in ambiguous cases.
Potential for discovering non-obvious bugs or optimization opportunities.

### Confidence Scoring

The confidence scoring mechanism, implemented through the model_confidence function, provides a way to assess the reliability of the model's outputs during code analysis.

Calculation method:
1. Transform logits into probabilities using a softmax function.
2. Weight the probabilities by the exponential of their respective logits.
3. Normalize the weighted probabilities to produce confidence scores.

Applications in code analysis:
Higher confidence scores may indicate more reliable bug identifications.
Optimization suggestions with high confidence scores could be prioritized.
Low confidence scores might flag areas requiring additional human review.

### Approximate CoT Generation

The approximate Chain-of-Thought (CoT) generation feature is designed to handle longer code sections efficiently while maintaining the overall reasoning quality.

Key aspects:
1. Generates multiple analysis steps for extended code segments.
2. Maintains high confidence in the overall reasoning path.
3. Balances efficiency and thoroughness in the analysis process.

Advantages:
Enables comprehensive analysis of large codebases.
Reduces computational overhead for lengthy code sections.
Preserves the quality of insights for complex software systems.

By combining these innovative techniques, the proposed system can provide more accurate, efficient, and insightful code analysis. The dynamic beam width adjustment allows for adaptive exploration of the solution space, the confidence scoring helps prioritize reliable findings, and the approximate CoT generation enables scalable analysis of large and complex codebases.

### Debugging Process

For debugging, the system might:
1. Analyze the code structure and logic flow, generating alternative explanations for each section.
2. Identify potential error sources by considering various execution paths.
3. Generate step-by-step debugging processes, explaining the reasoning behind each potential bug.
4. Provide detailed explanations of why certain code sections might lead to errors.

### Optimization Process

For code optimization, the system could:
1. Analyze the efficiency of algorithms and data structures used in the code.
2. Generate alternative implementations, explaining the reasoning behind each suggestion.
3. Provide step-by-step explanations of how proposed optimizations would improve performance.
4. Suggest specific code modifications with detailed rationales.

By leveraging the CoT reasoning extraction techniques, this system would provide more transparent and logically sound debugging and optimization suggestions compared to traditional approaches. The ability to generate and analyze multiple reasoning paths allows the system to consider various aspects of the code, potentially uncovering non-obvious bugs or optimization opportunities that might be missed by more straightforward analysis methods.

### Conclusion

The present invention introduces novel techniques to selectively elicit inherent CoT reasoning from language models through algorithmic decoding path extraction. While prior art demonstrates the existence of latent reasoning capabilities, the present disclosure provides important innovations to leverage these capabilities efficiently and effectively.

The dynamic beam width adjustment, confidence scoring, and other algorithms presented herein approximate brute force enumeration to isolate valid reasoning trajectories during decoding. These techniques apply sophisticated heuristics and metrics to guide the extraction of reliable CoT paths, enabling the elicitation and leveraging of a model's intrinsic aptitude for logical reasoning without exhaustive search or parameter tuning.

The invention achieves significant accuracy improvements by targeting high-confidence trajectories and represents vital advances in extracting and applying inherent CoT reasoning during language model decoding. These methods have great potential to amplify reasoning capabilities across a wide range of applications and domains by targeting untapped capabilities within existing models.

Furthermore, the techniques described herein may be adapted and applied to diverse types of pre-trained models and reasoning tasks, potentially revolutionizing how we approach problem-solving in artificial intelligence. The invention opens up new avenues for research and development in the field of natural language processing and reasoning, with far-reaching implications for enhancing the cognitive abilities of AI systems across diverse industries and use cases.

1. A system (100) for extracting inherent chain-of-thought reasoning from a pre-trained language model, comprising:
a pre-trained language model (102);
a chain-of-thought decoder (104) configured to:
receive an input text representing a reasoning task (106);
generate top-k alternative tokens at each decoding step (206);
analyze decoding paths to isolate high-confidence trajectories (208); and
output an extracted reasoning trajectory for solving the reasoning task (212).

2. The system of claim 1, wherein the chain-of-thought decoder is further configured to dynamically adjust a beam width during decoding based on entropy of model outputs.

3. The system of claim 2, wherein the chain-of-thought decoder adjusts the beam width by:
calculating a cumulative probability threshold based on historical entropy values;
identifying a minimal set of top logits that meet or exceed the adjusted threshold; and
setting the beam width to the number of identified top logits.

2. The system of claim 1, wherein the chain-of-thought decoder is further configured to calculate confidence scores for generated tokens using a weighted probability calculation.

5. The system of claim 4, wherein the weighted probability calculation comprises:
transforming logits into probabilities using a softmax function;
weighting the probabilities by the exponential of their respective logits; and
normalizing the weighted probabilities to produce confidence scores.

6. The system of claim 1, wherein the chain-of-thought decoder is further configured to implement approximate chain-of-thought generation for multiple characters when a confidence threshold is met.

7. The system of claim 1, wherein the chain-of-thought decoder is further configured to sort and trim candidate sequences based on their scores and lengths to adhere to a maximum batch size constraint.

8. The system of claim 1, wherein the pre-trained language model is a transformer model with an encoder-decoder architecture.

9. The system of claim 1, further comprising an input processor configured to tokenize the input text for consumption by the pre-trained language model.

10. The system of claim 1, wherein the chain-of-thought decoder is further configured to implement early stopping based on reaching a maximum token length or encountering an end token.

11. A method for extracting inherent chain-of-thought reasoning from a pre-trained language model, comprising:
receiving an input text representing a reasoning task;
generating, using a pre-trained language model, top-k alternative tokens at each decoding step;
analyzing decoding paths to isolate high-confidence trajectories; and
outputting an extracted reasoning trajectory for solving the reasoning task.

12. The method of claim 11, further comprising dynamically adjusting a beam width during decoding based on entropy of model outputs.

13. The method of claim 12, wherein dynamically adjusting the beam width comprises:
calculating a cumulative probability threshold based on historical entropy values;
identifying a minimal set of top logits that meet or exceed the adjusted threshold; and
setting the beam width to the number of identified top logits.

14. The method of claim 11, further comprising calculating confidence scores for generated tokens using a weighted probability calculation.

15. The method of claim 14, wherein the weighted probability calculation comprises:
transforming logits into probabilities using a softmax function;
weighting the probabilities by the exponential of their respective logits; and
normalizing the weighted probabilities to produce confidence scores.

16. The method of claim 11, further comprising implementing approximate chain-of-thought generation for multiple characters when a confidence threshold is met.

17. The method of claim 11, further comprising sorting and trimming candidate sequences based on their scores and lengths to adhere to a maximum batch size constraint.

18. The method of claim 11, further comprising tokenizing the input text for consumption by the pre-trained language model.

19. The method of claim 11, further comprising implementing early stopping based on reaching a maximum token length or encountering an end token.

20. The method of claim 11, wherein the pre-trained language model is a transformer model with an encoder-decoder architecture.

21. A non-transitory computer-readable medium storing instructions that, when executed by one or more processors, cause the one or more processors to perform operations for extracting inherent chain-of-thought reasoning from a pre-trained language model, the operations comprising:
receiving an input text representing a reasoning task;
generating, using a pre-trained language model, top-k alternative tokens at each decoding step;
analyzing decoding paths to isolate high-confidence trajectories; and
outputting an extracted reasoning trajectory for solving the reasoning task.

22. The non-transitory computer-readable medium of claim 21, wherein the operations further comprise dynamically adjusting a beam width during decoding based on entropy of model outputs.

23. The non-transitory computer-readable medium of claim 22, wherein dynamically adjusting the beam width comprises:
calculating a cumulative probability threshold based on historical entropy values;
identifying a minimal set of top logits that meet or exceed the adjusted threshold; and
setting the beam width to the number of identified top logits.

24. The non-transitory computer-readable medium of claim 21, wherein the operations further comprise calculating confidence scores for generated tokens using a weighted probability calculation.

25. The non-transitory computer-readable medium of claim 24, wherein the weighted probability calculation comprises:
transforming logits into probabilities using a softmax function;
weighting the probabilities by the exponential of their respective logits; and
normalizing the weighted probabilities to produce confidence scores.

26. The non-transitory computer-readable medium of claim 21, wherein the operations further comprise implementing approximate chain-of-thought generation for multiple characters when a confidence threshold is met.

27. The non-transitory computer-readable medium of claim 21, wherein the operations further comprise sorting and trimming candidate sequences based on their scores and lengths to adhere to a maximum batch size constraint.

28. The non-transitory computer-readable medium of claim 21, wherein the operations further comprise tokenizing the input text for consumption by the pre-trained language model.

29. The non-transitory computer-readable medium of claim 21, wherein the operations further comprise implementing early stopping based on reaching a maximum token length or encountering an end token.

30. The non-transitory computer-readable medium of claim 21, wherein the pre-trained language model is a transformer model with an encoder-decoder architecture.
